(19) United States
(12) Patent Application Publication
(10) Pub. No.: US 2010/0195535 A1
(43) Pub. Date: Aug. 5, 2010

(54) Methods, Networks and Network Nodes for Selecting a Route

(75) Inventors: Andreas Ziller, Muenchen (DE); Parag Sudhir Mogre, Darmstadt (DE); Matthias Hollick, Darmstadt (DE); Christian Schwingenschlögl, Putzbrunn (DE)

Correspondence Address: COHEN, PONTANI, LIEBERMAN & PAVANE LLP, 551 FIFTH AVENUE, SUITE 1210, NEW YORK, NY, 10176, US

(73) Assignee: Siemens AG, Munchen (DE)

(21) Appl. No.: 12/670,822

(22) PCT Filed: Jul. 16, 2008
(86) PCT No.: PCT/EP08/59297

§ 371 Date: Jan. 26, 2010

(30) Foreign Application Priority Data
Jul. 26, 2007 (DE) 10 2007 034 951.5
Jan. 26, 2008 (EP) 08001228.9

(51) Int. Cl. H04L 12/28; H04L 12/56

(52) U.S. Cl. 370/254; 370/389

(57) ABSTRACT

The invention relates to methods, networks and network nodes for setting up a route in a packet-switched network comprising network nodes which are connected to one another for data engineering purposes, where the route connects a starting node to a destination node through intermediate nodes. The route is set up with a distance correlation to a reference route which has already been set up in the network.

### CROSS REFERENCE TO THE RELATED APPLICATION

This is a U.S. national stage of application No. PCT/EP2008/059297, filed on Jul. 16, 2008. Priority is claimed on German Application No.: 10 2007 034 951.5, filed: Jul. 26, 2007; and European Application No.: EP08001228.9, filed: Jan. 23, 2008, the contents of which are incorporated herein by reference in their entirety.

### BACKGROUND OF THE INVENTION

1. Field of the Invention

The invention relates to network engineering and, more particularly, to methods, networks and network nodes for setting up a route that is distance-correlated with a reference route in a network.

2. Description of Prior Art

Networks enable data to be transmitted between interconnected network nodes. In order to utilize the advantages of connection-oriented data transmission in packet-switched networks, it is known to use data transmission methods whereby a logical route is dynamically set up for communication between a start and destination node of a network. This makes it possible to create a route such that certain quality of service features are achieved, for which purpose redundant standby or parallel routes are often also set up.

Particularly in a wireless network, the problem can arise that local interference in the coverage area of individual network nodes impacts the quality of service of all the routes running through the affected area. This may result in reduced reliability and longer reaction times in the event of a fault if an active route and also its standby route is impaired thereby.

This is explained in greater detail with reference to FIGS. 3 to 5 which show multi-hop networks with redundant parallel routes. In the Figures, the network nodes are represented as circles and (point-to-point) data links interconnecting two adjacent network nodes as lines. Data links associated with a route (end-to-end connection) are shown as thicker lines.

Turning first to FIG. 3, two different representations of the same network are shown, each having two parallel routes between a start node Q and a destination node Z. Intermediate nodes are denoted by N₁ . . . N₁₂.

In the left-hand illustration in FIG. 3, a first route I containing the network nodes Q, N₁, N₂, N₃, N₄ and Z in that order and a second route II parallel thereto and containing the network nodes Q, N₅, N₆, N₇ and Z in that order are set up. The two routes are a short distance from one another, i.e., they have a relatively high distance correlation, so that local interference caused by a network node in one of the two routes always also affects the other route.

In the right-hand illustration in FIG. 3, route I and a third route III parallel thereto and containing the network nodes Q, N₉, N₁₀, N₁₁, N₁₂ and Z in that order are set up. These two routes are a long distance from one another, i.e., they have a relatively low distance correlation, so that local interference of a network node only affects the other route in the vicinity of the source and destination node.

In FIG. 4 and FIG. 5, the effects of local interference caused by a network node in various networks is explained.

Turning first to FIG. 4, a wireless network with network nodes N₁ . . . N₈ is illustrated. Two parallel routes I, II are set up in the network, a first route I comprising the network nodes N₁, N₂ and N₃ in that order and a second route II comprising the network nodes N₆, N₇ and N₈ in that order. Route II is provided as a standby or backup route in the event of failure of the active route I. Only sections of the two routes are depicted here, in particular start and destination nodes not being shown.

In the network in FIG. 4, the network node N₄ does not belong to either of the two routes. As indicated by an arrow in FIG. 4, the network node N₄ transmits data to the network node N₅ which likewise does not belong to either of the two routes. If local interference caused by the network node N₄ occurs, resulting in communication between the network node N₄ and the network node N₅ occupying all the available bandwidth, the consequence of this is that bandwidth for data transmission is available neither to the network node N₂ of route I, directly adjacent to the network node N₄, nor to the network node N₇ belonging to route II. The network node N₂ of route I and the network node N₇ of route II are only separated from one another by the intermediate network node N₄, or rather two network node hops, i.e., two data links. Therefore, data transmission is impaired in both routes due to local interference caused by the network node N₄, so that no data communication is possible either via route I or via its backup route. In FIG. 4, the area of local interference is indicated by a dashed circle around the network node N₄.

FIG. 5 shows a wireless network with network nodes N₁ . . . N₉ in which a first route I comprising the network nodes N₁, N₂ and N₃ in that sequence and a second route II parallel thereto comprising the network nodes N₈, N₇ and N₉ in that order are set up. Route II is provided as a backup route in the event of failure of the active route I. The three serially interlinked network nodes N₄, N₅, and N₆ do not belong to either of the two routes and separate the two routes from one another so that the two routes I, II are separated from one another by more than 3 network node hops (in this case four data links).

As indicated by an arrow in FIG. 5, the network node N₄ transmits data to the network node N₅ whereby local interference from network node N₄ occurs which results in all the available bandwidth being used for communication between the network node N₄ and the network node N₅. As the local interference from the network node N₄ only affects the network node N₂ directly adjacent to network node N₄ and belonging to route I, local interference from the network node N₄ only impairs route I. Route II, which is more than 3 hops away from route I, is not affected by local interference from the network node N₄ and can take over data communication as a backup route.

In connection-oriented packet-switched networks, a plurality of different routing methods have hitherto been used for setting up redundant routes from a start node to a destination node. In terms of the characteristics of the routes set up, these methods can be classified into three categories:

In a first category, the routes are optimized in respect of node disjointness, with redundant routes also possibly having common network nodes, in which case problems caused by local interference and failed intermediate nodes affect all the routes set up.

In a second category, the routes are optimized in respect of node disjointness only and are always node-disjoint. Here node-disjoint routes can also contain network nodes which are within radio range of network nodes of another route. This means that problems due to local interference at network nodes on one route can also affect network nodes on another route. Locally occurring interference can therefore affect a plurality of routes. Unless there are a plurality of node-disjoint routes between a start node and a destination node, these methods cannot set up a plurality of non-node-disjoint routes as alternatives.

In a third category, the routes are optimized in respect of node disjointness only and need not be node-disjoint. Here node-disjoint routes can also contain network nodes which are within radio range of network nodes of another route. This means that problems due to local interference associated at network nodes on one route can also affect network nodes on another route. Locally occurring interference can therefore have a negative effect on a plurality of routes.

For example, in Aura Ganz, Qi Xue “Ad hoc QoS on-demand routing (AQOR) in mobile ad hoc networks” in Journal of Parallel and Distributed Computing, Volume 63, pages 154-165, 2003, a routing method is described in which the quality of the routes discovered is taken into account and the final route is selected according to its quality. In other routing methods, a plurality of routes are set up between source and destination nodes. For example, in Zhennqiang Ye, Srikanth V. Krishnamurthy, Satish K. Tripathi “A Framework for Reliable Routing in Mobile Ad-Hoc Networks” in IEEE INFOCOMM 2003, a routing method is shown in which the routes set up must be node-disjoint. In addition, in Stephen Mueller, Dipak Ghosal “Analysis of a Distributed Algorithm to Determine Multiple Routes with Path Diversity in Ad-Hoc Networks” in Modelling and Optimization in Mobile, Ad-Hoc and Wireless Networks, pages 277-285, April 2005, a method is described in which the routes set up can be node-disjoint.

However, none of the methods hitherto used for setting up redundant routes take adequate account of the effects of local interference from network nodes on the transmission characteristics of the routes.

### SUMMARY OF THE INVENTION

It is therefore an object of the present invention is to provide a method for setting up a route in a connection-oriented packet-switched network, enabling a route to be set up such that impairment of redundant routes by local interference from a network node can be avoided.

This and other objects and advantages are achieved in accordance with the invention by methods for setting up a route and by networks and network nodes suitably set up for performing these methods.

Terms will first be defined which have particular meaning in connection with the description.

### Term: “Connection”

A connection in a network is uniquely determined by:

A) a 2-tuple of the respective identifiers for start and destination node or

B) a 3-tuple of the respective identifiers for start node and destination node and class of service

The use of an n-tuple implies that each element of the tuple has a unique position. In other words, in a 2-tuple according to A), a connection R1=(X, Y) is not identical to a connection R2=(Y, X).

### Term: “Parallel Route”

All routes which exist for a connection between the same source and destination node are mutually parallel routes. The totality of all parallel routes are parallel routes. A route which is parallel to another route can be termed a parallel route. Equivalent terms for parallel route are alternative route, standby route and backup route. A parallel route is identified by a 4-tuple of the respective identifiers for start node, destination node, class of service and route number.

### Term: “Correlation”

The correlation (correlation factor) between two routes is a measure which stands in relation to the distance between the two routes or rather describes the distance between two routes. Correlation is understood here as meaning a distance correlation between routes.

### Term: “Distance Between Two Routes”

The distance between two routes results from the distance between each individual network node of a route and any other network node of the other route.

### Term: “Distance Between Two Network Nodes”

The distance between two network nodes is the number of intermediate nodes on a shortest path between the two network nodes.

### Term: “Aggregation”

By aggregation is meant the use of an aggregation function (scoring function) which combines one or more qualitative numerical or non-numerical quality features with one another, the respective quality features being weightable according to their importance. For example, the quality features path length 5, availability 70% and correlation 4 can be aggregated as follows: 0.2*5+10*70/100+0.5*4=10. The result produced by the scoring function is a score.

### Term: “Quality Feature”

A quality feature (quality of service feature) of a route is a route characteristic on the basis of which the quality of a route can be assessed. Examples of quality features are the correlation of the route with another route, expressed by a measure (correlation factor) or the maximum bandwidth available on that route.

### Term: “Local Interference”

Regarded as local interference is a data transmission disturbance in a wireline or wireless network which only affects transmission within the 3-hop adjacency around the network node causing the interference. This can be, for example, a network node which because of its transmitting behavior requires so much channel capacity that adjacent network nodes are unable to transmit or receive their own data in an interference-free manner. Depending on the characteristic of the local interference, its effects may also be limited to short inter-node distances. Also regarded as local interference in this context is the failure of a network node which only affects the transmission on routes which go through the failed network node.

In accordance with a first object of the invention, a first method is provided for setting up a distance-correlated route in a packet-switched network (multi-hop network) of data-linked network nodes. In the network, the network nodes can be data-linked to one another in a wired or wireless manner. The network nodes are preferably interlinked wirelessly.

In accordance with an embodiment of the invention, the route to be set up provides a data connection from a start node to a destination node through at least one intermediate node (end-to-end connection). In the network there is already a route providing a data connection between the start and destination mode, referred to here and hereinafter as the “reference route”. Here, the new route is set up in a distance-correlated manner with respect to the reference route.

In accordance with the first method of the invention, a plurality of test routes each interconnecting start and destination nodes through at least one intermediate node and having the associated quality of service features are determined. Considered as test routes here are temporary network paths between start and destination nodes which come into consideration for setting up as a route in the network.

For each test route, a correlation parameter (correlation measure) describing a distance correlation with the reference route present in the network is then calculated as a quality of service feature.

A scoring function for the weighted evaluation of quality of service features is then applied to at least one quality of service feature of the test routes determined, at least the calculated correlation parameter being included as a quality of service feature in the function argument, thereby producing a score for each test route. The correlation parameter here preferably has a maximum weight within the scoring function.

A test route is then selected from the plurality of test routes according to a selection rule for the test route scores and the selected test route is set up as a route in the network, which can be effected by means of a route reply or confirmation message.

By means of the selection rule, a test route is preferably selected such that the test route selected is more than 3 network node hops distant from the reference route (i.e., there are always at least four data links between the network nodes of the two routes). In particular, a route request can also be selected by the selection rule such that the network path traveled by the route request is as distant as possible from the reference route.

By means of an appropriate network protocol, the first method according to the invention can be implemented centrally in a network control device or decentrally in the network nodes.

The first method according to the invention enables a route to be set up that is distance-correlated with the reference route, wherein the route set up can in particular have a distance of more than 3 network node hops from the reference route. The advantage of this is that the probability of local interference from a network node in the network simultaneously affecting communication in the reference route and in the route set up in a distance-correlated manner therewith can be minimized or even eliminated.

In accordance with a second object of the invention, a network of data-linked network nodesis provided in which network a network protocol is implemented in the network nodes such that the network nodes can perform the method in accordance with the first object of the invention.

In accordance with a third object of the invention, a network node of a network of data-linked network nodesis provided in which a network protocol is implemented such that the network node can perform the method in accordance with the first object of the invention.

In accordance with a fourth object of the invention, a second method is provided for setting up a distance-correlated route in a packet-switched network (multi-hop network) of data-linked network nodes. In the network, the network nodes can be interconnected in a wired or wireless manner. The network nodes are preferably interconnected in a wireless manner.

In accordance with the objects of the invention, the route to be set up provides a data connection between a start node and a destination node through at least one intermediate node. In the network, there is already a reference route interconnecting the start and destination node, with which route the new route to be set up is distance-correlated.

In accordance with the second method of the invention for setting up a route, the start node first generates a route request (RREQ) as a routing message which is broadcast to the destination node. The route request contains at least one quality of service feature for describing the quality of service of the network path traveled by the route request, there being included as a quality of service feature at least one correlation parameter which describes a distance correlation of the network path traveled by the route request with the reference route in the network.

For each intermediate node receiving a route request, the following applies:

If an intermediate node receives a route request for the first time, the route request (RREQ) is stored in a route request buffer of the intermediate node. A first timer with a pre-settable first timeout period (T₁) is started, route requests received by the network node being stored in the route request buffer during the first timeout period.

In each intermediate node, for the route requests stored in the route request buffer, the quality of service features for the network path traveled by the route requests are supplemented in each case, i.e., for each route request, the quality of service features relating to the network path traveled, including that network node, are re-determined and added to the route request, in particular the correlation parameter being updated.

In each intermediate node, a scoring function for the weighted evaluation of quality of service features is applied to at least one quality of service feature of the route requests stored in the route request buffer, the correlation parameter being included as a quality of service feature in the function argument in any case, by means of which a first score is obtained for each route request.

Then, when the first timeout period has elapsed, a route request is selected from the route requests stored in the route request buffer according to a first selection rule for the first scores and the selected route request with the supplemented quality of service features is forwarded to adjacent network nodes in a broadcast manner.

A route request is preferably selected by means of the first selection rule such that the network path traveled by the route request always has a distance of more than 3 network hops (i.e., at least four data links) from the reference route. By means of the first selection rule, a route request can in particular also be selected such that the network path traveled by the route request is as far as possible from the reference route.

For the destination node receiving the route requests, the following applies:

If the destination node receives a route request forwarded by the intermediate nodes for the first time, the destination node stores the route request and starts a second timer with a pre-settable second timeout period (T₂). Route requests received during the second timeout period are stored in the route request buffer of the destination node.

In the destination node, for the route requests stored in the route request buffer, the quality of service features for the network paths traveled by the route requests are supplemented in each case, i.e., for each route request, the quality of service features relating to the network path traveled including the destination node are re-determined and added to the route request, in particular the correlation parameter being updated.

The scoring function is then applied to at least one quality of service feature of the route requests stored in the route request buffer of the destination node, the correlation parameter being included as a quality of service feature in the function argument in any case, thereby obtaining a second score for each route request. The correlation parameter preferably has a maximum weight within the scoring function.

When the second timeout period has elapsed, the destination node selects a route request from the route requests stored in the route request buffer according to a second selection rule for the second scores.

By means of the second selection rule a route request is preferably selected such that the network path traveled by the route request always has a distance of more than 3 network node hops from the reference route. By means of the second selection rule a route request can in particular also be selected such that the network path traveled by the route request is as far as possible from the reference route.

The destination node then selects as a routing message a route reply (RREP) containing at least the distance correlation with the reference route as a quality of service feature. This route reply is transmitted in the backward direction to the start node at least partially via the network path traveled by the selected route request in the forward direction, whereby the network path is confirmed as a route and therefore set up (established) in the network.

In accordance with the second method of the invention, the set up of a route is enabled which is distance-correlated with the reference route, making it possible to minimize the probability of communication in the reference route and in the route distance-correlated therewith being simultaneously affected by local interference from a network node. The second method can be simply implemented in technical terms and provides reliable and secure setup of a route which distance-correlated with the reference route between start and destination nodes.

In a particularly advantageous embodiment of the second method of the invention, the following applies to each intermediate node receiving a route request:

The first time a route request (RREQ) is received, the intermediate node starts a third timer with a pre-settable third timeout period (T₃), the start time and duration of the third timeout period being selected such that the third timeout period expires after the first timeout period.

Request messages received during the course of the third timeout period are stored in the route request buffer of the intermediate node. In addition, for each route request stored in the route request buffer, its quality of service features are determined taking that network node into account and the quality of service features of the route request are supplemented accordingly.

In addition, the scoring function for the weighted evaluation of quality of service features is applied to at least one quality of service feature of the route requests stored in the route request buffer of the intermediate nodes during the course of the third timeout period, at least the calculated correlation parameter being included in the function argument, thereby obtaining a first score for each such route request.

The following also applies to each intermediate node receiving a route reply:

On receiving a route reply, the intermediate node checks whether a route request stored in the route request buffer of the intermediate node on expiration of the first timeout period and during the third timeout period has according to the first selection rule a better score than the route request forwarded upon expiration of the first timeout time.

In the event that no higher scored route request is present in the intermediate node, the route reply is forwarded in the backward direction along the network path traveled by the route request selected by the destination node.

Alternatively, in the event that a higher scored route request is present in the intermediate node, the route reply is forwarded in the backward direction along the network path traveled by the route request scored higher by the intermediate node.

In the presently comtemplated embodiment of the second method, the case can advantageously be taken into account that, on expiration of the first period, an intermediate node has received during the course of the third timeout period a higher scored route request, so that the route to be set up can be further improved in respect of the desired quality features, here in particular the distance correlation with the reference route.

In accordance with a preferred embodiment of the second method, a route reply received by an intermediate node is only forwarded if the third timeout period has not yet expired, thereby enabling the overall route setup time to be limited.

In accordance with a fifth object of the invention, a network of data-linked network nodes is provided in which a network protocol is implemented in the network nodes so that the network nodes can perform the second method in accordance with the fourth object of the invention.

In accordance with a sixth object of the invention, a network node of a network of data-linked network nodesis provided in which a network protocol is implemented so that the network node can carry out a second method according to the fourth object the invention.

In accordance with a seventh object of the invention, a third method is provided for setting up a distance-correlated route in a packet-switched network (multi-hop network) of data-linked network nodes. In the network, the network nodes can be interconnected in a wired or wireless manner. The network nodes are preferably wirelessly interconnected.

In accordance with the disclosed embodiment, the route to be set up provides a data connection between a start node and a destination node via at least one intermediate node. In the network, there are already exists a reference route providing a data connection between the start and destination node, in respect of which the new route is to be set up in a distance-correlated manner.

In accordance with the third method of the invention for setting up a route, the start node first generates, as a routing message, a route request (RREQ) which is broadcast to the destination nodes. The route request contains at least one quality of service feature for describing the quality of service of the route, there being included as a quality of service feature at least one correlation parameter which describes a distance correlation of the network path traveled by the route request with the reference route in the network.

For each intermediate node receiving a route request, the following applies:

If an intermediate node receives a route request for the first time, the route request is stored in a route request buffer of the intermediate node. A first timer with a pre-settable first timeout period (T₁) and a third timer with a pre-settable third timeout time (T₃) are simultaneously started, route requests received by the network node being stored in the route request buffer during the first timeout period and during the third timeout period.

In each intermediate node, the quality of service features for the network path traveled by the route request in each case are supplemented for the route requests stored in the route request buffer, i.e., for each route request, quality of service features relating to the network path traveled including that network node are re-determined and added to the route request, in particular the correlation parameter being updated.

In each intermediate node, a scoring function for the weighted evaluation of quality of service features is then applied to at least one quality of service feature of the route requests stored in the route request buffer, the correlation parameter being included in any case as a quality of service feature in the function argument, thereby obtaining a first score for each route request.

Upon expiration of the first timeout period, a route request is then selected from the route requests stored in the route request buffer according to a first selection rule for the first scores and the selected route request is forwarded in a broadcast manner to adjacent network nodes.

A route request is preferably selected by the first selection rule such that the network path traveled by the route request is always more than 3 network hops (i.e., at least four data links) from the reference route. A route request can in particular be selected by the first selection rule such that the network path traveled by the route request is as far as possible from the reference route.

The following applies to the destination node receiving the route requests:

If the destination node receives a route request forwarded by the intermediate node for the first time, it stores the route request and starts a second timer with a pre-settable second timeout period (T₂). Request messages received during the second timeout period are stored in the route request buffer of the destination node.

In the destination node, the quality of service features for the network path traveled by the route requests in each case are supplemented for the route requests stored in the route request buffer, i.e., for each route request, the quality of service features relating to the network path traveled including the destination node are re-determined and added to the route request, in particular the correlation parameter being updated.

The scoring function is then applied to at least one quality of service feature of the route requests stored in the route request buffer of the destination node, the correlation parameter being included in any case as a quality of service feature in the function argument, thereby obtaining a second score for each route request. The correlation parameter preferably has a maximum weighting within the scoring function.

On expiration of the second timeout period, the destination node selects a plurality of route requests according to a second selection rule for the second scores from the route requests stored in the route request buffer.

Route requests are preferably selected by the second selection rule such that the network paths traveled by the route requests are always more than three network hops away from the reference route. By means of the second selection rule, the route requests can in particular also be selected such that the network paths traveled by the route requests selected, beginning with the network path having a maximum distance from the reference route, have a progressively decreasing distance from the reference route.

The destination node then generates, as a routing message, a route reply (RREP) containing at least the distance correlation with the reference route as a quality of service feature, said route reply being transmitted in the backward direction to the start node at least partly via the respective network paths traveled in the forward direction by the route requests selected.

The following applies to each intermediate node receiving a route reply:

On receiving a route reply, the intermediate node checks whether a route request stored in the route request buffer of the intermediate node on expiration of the first timeout period and during the third timeout period has according to the first selection rule a better score than the route request forwarded on expiration of the first timeout period.

If no higher scored route request is present in the intermediate node, the route reply is forwarded in the backward direction along the network path traveled by the route request selected by the destination node.

Alternatively, in the event that a higher scored route request is present in the intermediate node, the route reply is forwarded in the backward direction along the network path traveled by the route request scored higher by the intermediate node.

The following applies to the start node receiving the route replies:

The first time a route reply is received, the start node stores the route reply in a route reply buffer and starts a fourth timer with a pre-settable fourth timeout period (T₄).

Route replies received during the fourth timeout period are stored in the route reply buffer. In the start node, the quality of service features for the network paths traveled by the route replies in each case are additionally supplemented for the route replies stored in the route reply buffer, i.e., for each route request, the quality of service features relating to the network path traveled including the start node are re-determined and added to the route reply, in particular the correlation parameter being updated.

The scoring function is then applied to at least one quality of service feature of the route replies stored in the route reply buffer of the start node, thereby obtaining a third score for each network path traveled by a route reply

On expiration of the fourth timeout period, a route reply is selected from the route replies stored in the route reply buffer of the start node according to a third selection rule for the scores. By means of the third selection rule, a route reply is preferably selected such that the network path traveled by the route reply always has a distance of more than 3 network node hops from the reference route. The route reply can in particular be selected by the third selection rule such that the network path traveled by the route reply selected has a maximum distance from the reference route.

The network path selected is then set up (established) by a data packet transmitted from the start node to the destination node which is sent to the destination node in the forward direction via the network path traveled by the route reply selected. For this purpose, the start node can generate a route confirmation message (RCFM) which is transmitted to the destination node.

Alternatively, the route can also be confirmed by a first payroll data packet (which is different from a routing message sent as part of the network protocol). This is advisable, as a payroll data packet may overtake the confirmation message or a confirmation message can be lost.

The third method in accordance with the invention enables a route that is distance-correlated with the reference route to be set up, thereby minimizing the probability of local interference from a network node simultaneously affecting communication in the reference route and in the route set up in a distance-correlated manner with said reference route. The third method can be implemented in a technically simple manner and allows reliable and secure setup of a route between start and destination node that is distance-correlated with the reference route.

The third method in accordance with the invention also enables it to be advantageously taken into account, for a plurality of network paths which have already been selected in the forward direction from the start to the destination node in respect of the desired quality features, that, on expiration of the first timeout period and during the course of the second timeout period, an intermediate node has received a higher scored route request, so that the route to be set up can also be further improved in the backward direction from the destination node to the start node in respect of the desired quality features, here in particular the distance correlation with the reference route.

In accordance with the third method, a route reply received by an intermediate node is preferably only forwarded if the third timeout period has not yet expired, thereby enabling the overall route setup time to be limited.

In accordance with an eighth object of the invention, a network of data-linked network nodes is provided in which a network protocol is implemented in the network nodes so that the network nodes can perform the third method in accordance with the seventh object of the invention.

In accordance with a ninth object of the invention, a network node of a network of data-linked network nodes is provided in which a network protocol is implemented so that the network node can perform the third method in accordance with the seventh object of the invention.

In accordance with a particularly advantageous embodiment of the method according to the invention, a route parallel to the reference route is set up so that redundant routes for communication can be set up in a distance-correlated manner. As a result, it is possible to minimize the possibility of an active route for communication and its standby route being adversely affected in the event of local interference from a network node.

In accordance with another particularly advantageous embodiment of the method according to the invention, each network node exchanges route information messages with other network nodes, each route information message containing data which describes whether a network node transmitting the route information message is part of the reference route. Particularly advantageously, each route information message contains data which describes whether a network node adjacent to the network node transmitting the route information message is part of the reference route, each route information message preferably being able in particular to contain data which describes whether a network node within a 1-hop, 2-hop or 3-hop adjacency to the network node transmitting the route information message is part of the reference route. This provides each network node with a technically simple and reliable means of determining the distance correlation with the reference route of a network path traveled by a routing message.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention will now be explained in greater detail on the basis of an exemplary embodiment and with reference to the accompanying drawings, in which:

FIG. 1 schematically illustrates an exemplary embodiment of the invention;

FIG. 2 shows another schematic illustration of another exemplary embodiment of the invention;

FIG. 3 shows, in a first schematic, a network with two strongly correlated parallel routes and, in a second schematic, a network with two minimally correlated parallel routes;

FIG. 4 shows a schematic illustration of a network with two strongly correlated parallel routes which are affected by local interference from a network node;

FIG. 5 schematically illustrates a network with two minimally correlated parallel routes of which only one route is affected by local interference from a network node; and

FIG. 6 is a flow chart showing the method in accordance with an exemplary embodiment of the invention.

### DETAILED DESCRIPTION OF THE PREFERRED EMBODIMENTS

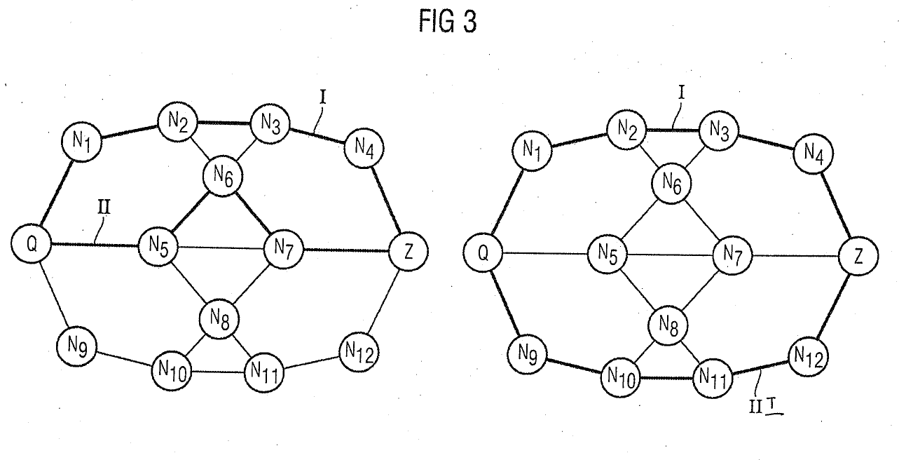

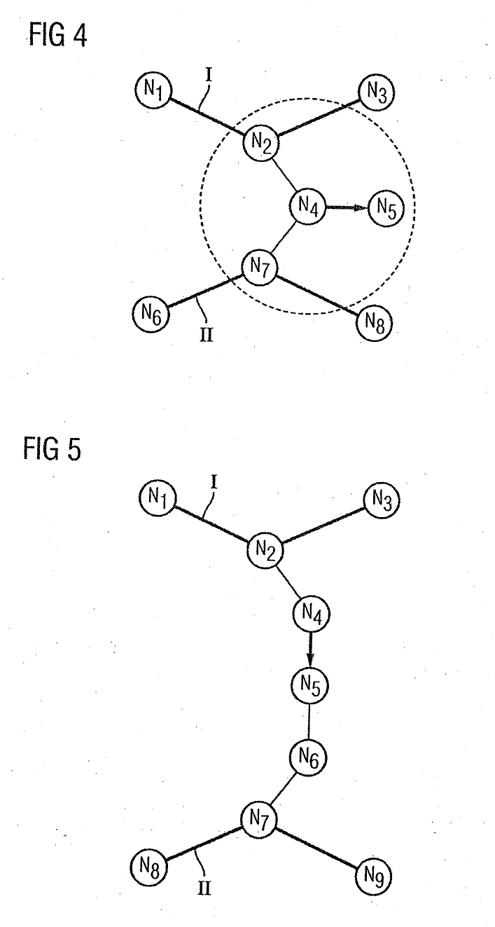

As FIGS. 3 to 5 have already been explained in detail in the introduction to the description, they will not be described further here.

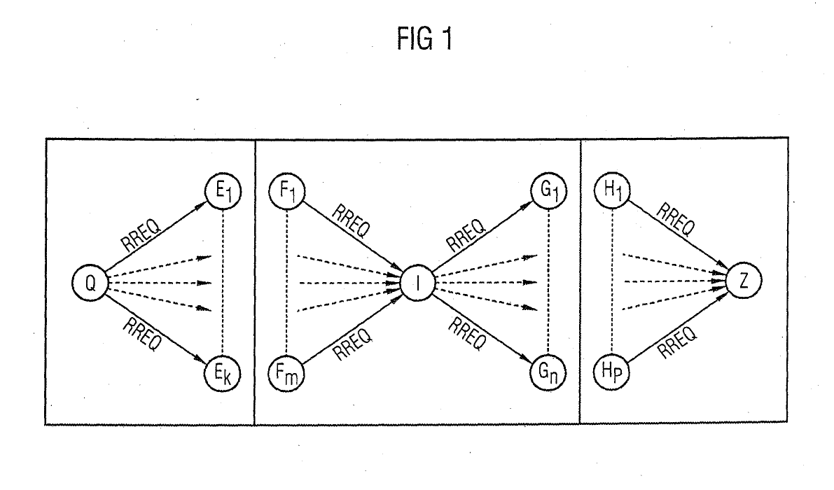

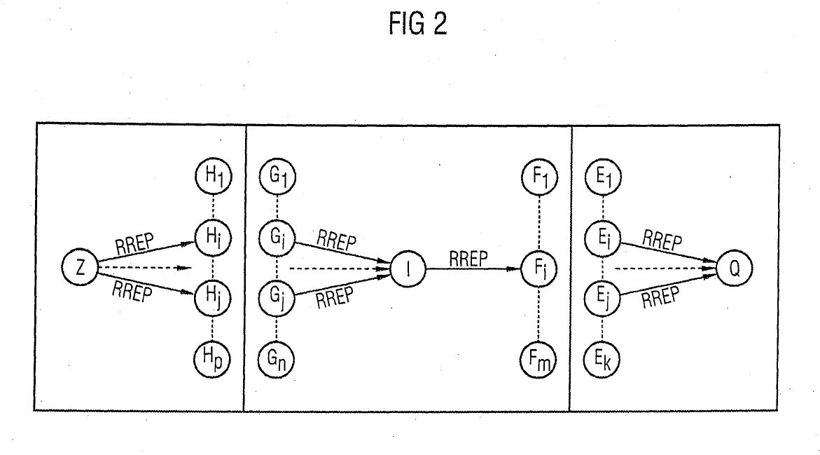

An exemplary embodiment of the invention will now be described with reference to FIG. 1 and FIG. 2.

FIGS. 1 and 2 show a wireless meshed connection-oriented packet-switched network (multi-hop network) with a plurality of network nodes interconnected by point-to-point data links, each node being denoted by a subscripted character. The network nodes are each equipped with processing devices suitable for data processing, and are provided with transmitting and receiving devices for transmitting and receiving data packets. A network protocol decentrally implemented in the network nodes is used to perform an exemplary embodiment of a method in accordance with the invention.

In accordance with the contemplated embodiments of the method of the invention, on the basis of a connection request (request for a route from a start node Q to a destination node Z), a sequence of process steps for setting up the route in the network is initiated which are collectively known as “route discovery”. The same route discovery is uniquely identifiable by the addresses of the start and destination node, a class of service and a route number.

The route to be set up by means of the method in accordance with the contemplated embodiments of the invention has a distance of more than 3 network node hops from a route (reference route) already existing in the network, here, e.g., a parallel route. It is assumed that such a parallel route already exists in the network. For example, it may have been set up by an earlier route discovery of the method according to the invention.

For this purpose, the start node Q first generates as a routing message a route request RREQ which is transmitted in a broadcast manner to all the nearest neighbors of the start node Q. This is illustrated in FIG. 1, left-hand diagram, in which the start node Q and the nearest neighbors E₁ . . . Eₖ of the start node Q are shown, arrows being used to symbolize the sending out of the route request RREQ.

The message format of the route request RREQ is, for example, as follows:

| | Size |
|---|---|
| Field | |
| message type | 4 bit |
| source address | 32 bit |
| destination address | 32 bit |
| class of service | 8 bit |
| route number | 8 bit |
| route request number | 16 bit |
| Quality of service information: | |
| correlation factor | 16 bit |
| qualified queue length | 16 bit |
| minimum reserved bandwidth | 8 bit |
| minimum free bandwidth | 8 bit |
| length of route | 8 bit |

Accordingly, the route request RREQ contains an identifier for the message type (in this case “route request”), a start node identifier, a destination node identifier, an identifier of the desired class of service, a route number for identifying the route to be set up and a route request number for identifying the route request RREQ.

Also contained therein are various items of quality of service information for describing characteristics of the network path traveled by the route request, including in particular a correlation factor (correlation parameter) which specifies the distance correlation of the route to be set up with the parallel route already existing in the network. Other items of quality of service information are a qualified queue length, the minimum bandwidth which is reserved for data transmission on the route, a minimum free bandwidth and the length of the route.

The following applies to every intermediate node between the start node Q and the destination node Z:

If an intermediate node of the network receives a route request RREQ of the same route discovery for the first time, it stores the route request RREQ in a route request buffer and starts a first timer with a pre-settable first timeout period T₁ and a third timer with a pre-settable third timeout period T₃. The start time and length of the two timeout periods are selected such that the third timeout period T₃ does not expire until after the first timeout period T₁.

During the course of the first timeout period T₁ and during the course of the third timeout period T₃, all incoming route requests RREQ to this intermediate node that are associated with the same route discovery are buffered in the route request buffer. Therefore, even on expiration of the first timeout period T₁, all the incoming route requests RREQ belonging to the same route discovery are buffered in the route request buffer until expiration of the third timeout period T₃.

On expiration of the first timeout period T₁, a route request is selected by the intermediate node from all the route requests stored in the route request buffer RREQ during the course of the first timeout period T₁. Selection takes place on the basis of the quality features stored as quality of service information in the route requests RREQ. For this purpose, each intermediate node updates the quality of service information of the buffered route requests.

In the intermediate node, for each buffered route request RREQ, an aggregation or scoring function is performed for this purpose which makes it possible to weight the (updated) quality features of the route request RREQ. By way of result, the scoring function produces a score for each route request RREQ. The correlation factor, i.e., a measure of the distance correlation of the network path traveled by the route request with the parallel route already set up in the network, is particularly taken into account here as a quality feature. Of the quality features evaluated in the scoring function, the correlation factor is preferably given the highest weight (priority).

A route request RREQ is selected by the intermediate node from the buffered route requests RREQ according to a selectable selection rule for the results of the scoring function, a route request RREQ being selected here whose network path traveled has a distance of more than 3 network node hops from the reference route. In particular, it is also possible for the route request RREQ whose network path traveled has a lowest correlation, i.e., a greatest distance from the existing parallel route, to be selected.

The network node then modifies the selected route request RREQ by adjusting all the routing-relevant information of the network node. In the route request RREQ, the quality of service information is therefore updated, in particular the correlation factor of the route to be set up with the existing parallel route being adjusted, taking into account the network node transmitting the route request RREQ.

To enable the network node to determine the correlation with a route, in the method in accordance with the contemplated embodiments of the invention all the network nodes exchange information about routes in the adjacency of a network node by means of route information messages. By transmitting route information, each network node informs all the nearest adjacent nodes as to which routes include it as an intermediate node and which routes go via network nodes in its 1-hop, 2-hop and 3-hop adjacency.

Based on the information communicated by the route information messages, the correlation of a route can be calculated, each intermediate node carrying out for this purpose an aggregation of the total number of intermediate nodes of a route in 1-hop, 2-hop and 3-hop adjacency, and the number of parallel routes which go through the corresponding network node. An addition can be used as the aggregation function. The number of parallel routes is weighted by distance for the aggregation. The weighting is in ascending order from routes in three-hop adjacency to routes on the network node.

In this example, the route information messages are transmitted in respect of the reference route, which is a parallel route. The contemplated embodiments of the method can equally be used to determine and take account of correlation with routes of another connection (not parallel routes).

A example of an algorithm for determining the correlation on the basis of adjacency information is given below:

```
function CORRELATION(srcAddr, dstAddr, serviceClass, routeNumber)
    correlationFactor ← 0
    for all i ε <routes on local node> do
        if is parallel(srcAddr, dstAddrm, serviceClass) then
            correlationFactor ← correlationFactor + 12
        end if
    end for
    for all i ε <routes on direct neighbors> do
        if is parallel(srcAddr, dstAddrm, serviceClass) then
            correlationFactor ← correlationFactor + 3
        end if
    end for
    for all i ε <routes with a distance of three edges> do
        if is parallel(srcAddr, dstAddrm, serviceClass) then
            correlationFactor ← correlationFactor + 3
        end if
    end for
    for all i ε <routes with a distance of four edges> do
        if is parallel(srcAddr, dstAddrm, serviceClass) then
            correlationFactor ← correlationFactor + 1
        end if
    end for
    return correlationFactor
end function
```

The network node then broadcasts the modified route request RREQ to all its nearest neighbors.

This is illustrated in the middle diagram in FIG. 1 which shows an intermediate node I which receives route requests RREQ from a plurality of intermediate nodes F₁ . . . Fₘ, buffers the received route requests RREQ in the route request buffer, selects from them a route request RREQ, modifies the selected route request RREQ according to its own routing-relevant information and broadcasts this modified route request RREQ to all immediately adjacent network nodes G₁ . . . Gₙ. Each network node stores the information about the network node from which it has received the respective route request RREQ.

The destination node Z finally receives route requests RREQ from its adjacent nodes H₁ . . . Hₚ, as illustrated in the right-hand diagram in FIG. 1. On receiving the first route request RREQ of a same route discovery, the destination node Z starts a second timer with a pre-settable second timeout period T₂. During the course of the second timeout period T₂, the destination node Z buffers all the received route requests RREQ in a route request buffer.

On expiration of the second timeout period T₂, a plurality of route requests RREQ are selected by the destination node Z from the route requests RREQ stored in the route request buffer. A route request RREQ is selected on the basis of the quality features stored as quality of service information in the route requests RREQ, a scoring function as already performed in the intermediate node being applied after updating of the quality features. The quality features are preferably weighted in the scoring function such that the correlation factor is assigned a maximum weight among the quality features.

The plurality of route requests RREQ are selected according to a selection rule for the scores, route requests being selected here whose network path traveled has a distance of more than 3 network node hops from the reference route, for example. In particular, the route requests RREQ with progressively increasing correlation with the parallel route, beginning with the route request RREQ having the lowest correlation with the parallel route, can also be selected. By selecting a plurality of route requests RREQ, a plurality of possible parallel forward routes between start and destination node can be selected in which, for example, a maximally high distance correlation with the parallel route already set up can be realized.

The destination node Z then generates a route reply (RREP) with updated quality of service information for the network paths traveled which is unicast to all the adjacent intermediate nodes from which the route requests RREQ selected have been received. This is shown in FIG. 2, left-hand diagram, which schematically illustrates that the destination node Z transmits a plurality of route replies to the immediately adjacent network nodes H₁ . . . Hₚ.

The message format of the route reply RREP is here, for example, as follows:

| | Size |
|---|---|
| Field | |
| message type | 4 bit |
| source address | 32 bit |
| destination address | 32 bit |
| class of service | 8 bit |
| route number | 8 bit |
| route request number | 16 bit |
| Quality of service information: | |
| correlation factor | 16 bit |
| qualified queue length | 16 bit |
| minimum reserved bandwidth | 8 bit |
| minimum free bandwidth | 8 bit |
| length of route | 8 bit |

Each intermediate node which receives a route reply RREP unicasts said route reply on to the nearest network node from which it has received the forwarded route request RREQ. The precondition for the forwarding of a route reply RREP by an intermediate node is that the second timeout period T₂ of the associated route discovery of the intermediate node has not yet elapsed. If the associated second timeout period T₂ of the associated route discovery has already elapsed, the route reply RREP is not processed further.

The route reply RREP is therefore unicast to the start node Q in the backward direction of the forward routes defined by the route requests RREQ selected. The route selected is communicated to all the receiving intermediate nodes and the start node Q via the route reply RREP. Each intermediate node which receives a route reply RREP can assign it to a route discovery on the basis of the address of the start node and the route request number.

It is also possible for an intermediate node to receive a plurality of route replies RREP which are forwarded to a plurality of network nodes from which it has received the corresponding route requests RREQ.

As an intermediate node buffers incoming route requests RREQ in the route request buffer until expiration of the third timeout period T₃, i.e., even after a route request RREQ has been sent out, the case can arise that a higher scored route is defined by a route request RREQ received after expiration of the third timeout period T₃. Here, the intermediate node forwards the route reply RREP to the preceding nodes from which it has received the best (highest scored) buffered route request RREQ. For this purpose the route reply is supplemented with appropriate quality features. As a result, it is possible to take account of subsequent route improvements by means of route requests RREQ received in the intermediate node after a route request RREQ has already been sent out. The best route request RREQ is selected by applying the scoring function and selecting according to the selection rule for the score (e.g. lowest correlation with the parallel route already present).

The foregoing is illustrated in FIG. 2, middle diagram, which shows an intermediate node I which receives route replies RREP from a plurality of intermediate nodes Gᵢ . . . Gⱼ and transmits them to a network node F₁ from which it has received the route request RREQ with the best route.

As an intermediate node buffers route requests RREQ in the route request buffer until the third timeout period T₃ has expired, the case can also arise that a route request RREQ is buffered which reaches that network node again on a loop in the network, e.g. by being broadcast to the network node by a following network node. Since, however, unlike in a source routing method, no information concerning the already visited network nodes is stored in the protocol messages, looping cannot be readily detected. However, if a route request RREQ cannot be detected as being on a loop, it could under some circumstances be selected for setting up a backward route when a route reply RREP comes in. The route reply RREP would then take the same path backward as the route request RREQ and arrive again at the exit point of the loop. As the network node at this juncture determines the further course of the backward route according to the same criteria, the route reply RREP would remain on the loop until it was deleted on the basis of a maximum run time (TTL=Time To Live).

In order to prevent looping, route requests RREQ that have already passed through a network node must be prevented from being taken into account again. However, this is not readily possible, as the path of a message cannot be tracked. In order to nevertheless avoid looping, a heuristic is used in which a received route request RREQ is only buffered in the route request buffer if no other route request RREQ is stored there that is not worse in all quality features (quality of service information). The following algorithm, for example, can be used for this purpose:

```
function IsNotOnALoop(r)
    for all i ε Q do (Q is the set of buffered route requests RREQ)
        if corr(i) ≦ corr(r) $$ delay (i) ≦ delay(r) $$ hops(i) <
        hops(r) then
            return false
        end if
    end for
    return true
end function
```

A route request RREQ is therefore not buffered if it is on a loop. The original route request RREQ from which the repeatedly received route request RREQ derives is always in the route request buffer. For this reason, there is present in the route request buffer at least one route request RREQ which because of monotonicity is not worse in all quality features than the repeatedly received route request RREQ. A route request RREQ that is on a loop is therefore detected in each case.

When the start Q receives the first route reply RREP of the route discovery, it starts a fourth timer with a selectable fourth timeout period T₄. During the course of the fourth timeout period T₄, further incoming route replies RREP are buffered in a route reply buffer of the start node Q.

On expiration of the fourth timeout period T₄, the start node Q selects a route request from the route requests RREQ stored in the route request buffer. The route request RREQ is selected on the basis of the quality features stored in the route requests RREQ as quality of service information, for which purpose a scoring function is applied as already in the intermediate nodes and in the destination node. The quality features are weighted in the scoring function such that the correlation factor is assigned a maximum weight among the quality features. For example, the route reply with the lowest correlation with the parallel route already set up in the network is selected as the best route reply RREP.

The start node Q then generates a confirmation message which is transmitted to the destination node Z via the forward route associated with the route reply RREP, thereby confirming the route selected and setting up the route.

The message format of the confirmation message is here, for example, as follows:

| Field | Size |
|---|---|
| message type | 4 bit |
| source address | 32 bit |
| destination address | 32 bit |
| class of service | 8 bit |
| route number | 8 bit |

The following applies to each intermediate node: if an intermediate node receives such a confirmation message, the intermediate node inserts a corresponding entry in its routing table. This entry contains the address of the start node, the address of the destination node, the class of service, the number of the route, the address of the network node transmitting the confirmation message (preceding address) and the address of the following network node (following address). Entering the preceding address also allows data transmission in the backward direction from the destination to the start node, so that a bidirectional connection path to set up. Communication in the direction of the start node is particularly important if the start node is to be informed about a deterioration in the quality of service.

When the destination node Z receives the confirmation message, the new route is set up in the network.

On completion of route discovery during which a new route that is distance-correlated with a parallel route already present in the network has been set up in the network, the start node checks whether at least one other parallel route i.e., redundant route is present in the network. In the above example it was assumed that a parallel route is already present in the network.

In the event that no route has yet been set up in the network, two different route discoveries are run through consecutively, the first route being set up in the first route discovery and a second route distance-correlated to the first route being set up in the second route discovery. For setup of the first route, the value of the correlation factor is zero, as a correlation with an already existing route cannot be taken into account.

In accordance with the contemplated embodiments of the method of the invention, by using a scoring function, a route with a particularly low correlation with an e.g. parallel route in the network can be discovered and set up. This implies that a node-disjoint route will be found if any such exists. This also implies that a non-node-disjoint route will be found if there is no node-disjoint route.

In accordance with the contemplated embodiments of the method of the invention, a route with a large distance, in particular with a distance of more than 3 network node hops, e.g. having a maximum possible distance from a reference route can be set up, which has the advantage that the probability of local interference affecting both routes is minimized. By successively running through a plurality of route discoveries, a plurality of routes can be generated in this way.

If in the routes set up each network node of a route is at a distance of more than three hops from any network node of the other route, local interference causing quality of service impairment of one route can have no effect on the quality of service of the other route.

If data communication takes place exclusively along a route and an impairment in quality of service occurs during data communication or an intermediate node of the active route fails, the data traffic can be handled over a parallel route which then becomes the active route. In this case a parallel route is set up as a standby connection path without preventing the existing data transmission. The previous route can be cleared down by a cleardown message (route destruction) transmitted from the start node to the destination node.

The message of format of such a cleardown message is e.g. as follows:

| Field | Size |
|---|---|
| message type | 4 bit |
| source address | 32 bit |
| destination address | 32 bit |
| class of service | 8 bit |
| route number | 8 bit |

In accordance with the contemplated embodiments of the method of the invention, each network node administers a routing table for the bidirectional forwarding of incoming data packets. The routing table assigns an address for the next hop of the data packet to a 4-tuple of start node address, destination node address, class of service and route number. The source and destination node addresses are taken from the corresponding fields of the IP header of the data packet. The class of service and the route number are taken from the ToS field of the IP header. For this purpose the two values must be stored in binary coded form. The assignment of an incoming data packet at an intermediate node to a route is required, as a plurality of routes can go via a same network node and therefore it is possible for data packets to be forwarded via incorrect adjacent nodes.

With the aid of the contemplated embodiments of method in accordance with the invention, in particular parallel routes can be set up which can be arbitrarily independent of one another taking into account the distance correlation. Here a route, in particular a parallel route, can be set up which has a maximally low correlation with all other routes set up. The method according to the invention is therefore able to discover routes even when, because of a limited topology of the network, no routes are to be found which have required criteria for a correlation.

In contemplated embodiments of the method of the invention, local interference which would mean a quality of service impairment for a route can be prevented from also affecting the quality of service of one or more other routes. The quality of service for a connection can therefore also be maintained if one or more routes, in particular parallel routes, fail or experience quality of service impairment because of local interference.

By means of the contemplated embodiments of the method in accordance with the invention, the correlation i.e., the distance between two routes, in particular parallel routes, can be calculated decentrally by local information exchange between the network nodes and this information can be taken into account for route setup. This avoids an overhead due to network-wide information exchange, and scalability is improved.

In the contemplated embodiments of the method in accordance with the invention, the network nodes perform a scoring function which can calculate the quality of a route as a function of weighted quality features, so that it can be compared with the quality of another route. Since with said scoring function the quality of a route can be taken into account for route setup, a better quality of service is made possible via the route set up, so that the load can be better distributed over the network.

The contemplated embodiments of the method in accordance with the invention is able to optimize routes in respect of any quality features for which an algebra is defined in each case. It evaluates locally received route requests and forwards them if necessary, in particular multiple forwarding also being possible. In this way, routes can also be set up which, although longer than the shortest possible routes, allow better data transmission in respect of their quality features. For example, routes can be set up which allow a higher data throughput and a lower delay when compared to conventional methods. In addition, the load situation can be taken into account for route setup. Moreover, in the contemplated embodiments of the method of the invention, it can be assessed by means of a plausibility check of the accompanying quality features of the route requests RREQ whether these have already been forwarded by a particular network node, so that routes with loops can be avoided.

Through the possibility of diverting data traffic onto a parallel route, taking a distance correlation into account, in the event of the occurrence of local interference or network node failure, a quality of service impairment to data transmission can be avoided.

The contemplated embodiments of the method in accordance with the invention can assign L3 packets (L3=Layer 3), i.e., data packets from Layer 3 (Network Layer) of the OSI (Open systems Interconnection) model, to a connection. The quality of service features of a route are typically connection features of Layer 1 (Physical Layer) and Layer 2 (Data Link Layer) of the OSI model. In the routing messages (route request, route reply) of the network protocol, the quality of service features of a route are stored in aggregated or non-aggregated form in a data container with at least one data structure, each network node of a route being able to be allocated a separate data structure.

In each disclosed embodiment of the method, the quality of service on all routes set up can be continuously monitored using test data packets.

Using the contemplated embodiments of the method in accordance with the invention, a plurality of parallel forward routes are signaled so that a plurality of routes are available for selection by the destination node, thereby improving routing quality. As a plurality of route replies RREP can be transmitted from the destination node, subsequent route improvements can be taken into account by route requests RREQ received in the intermediate nodes even after a route request RREQ has been sent out.

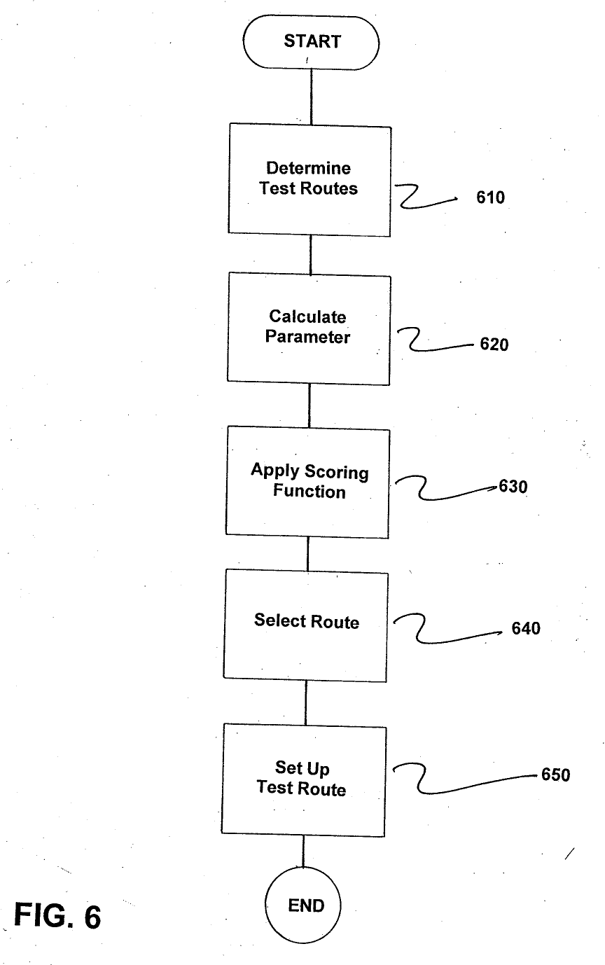

FIG. 6 is an exemplary flow chart of a method for setting up a route in a packet-switched network of data-linked network nodes, where the route connects a start node to a destination node through intermediate nodes. The method comprises determining a plurality of test routes with respective quality of service features, as indicated in step 610.

Next, a correlation parameter is calculated for each test route which describes a distance correlation with a reference route present in the network, as indicated in step 620.

A scoring function is then applied for a weighted evaluation of quality of service features to at least one quality of service feature of each test route to obtain a score for each test route, as indicated in step 630. Here, a correlation parameter is included as a quality of service feature in a function argument.

Next, a test route is selected according to a selection rule for the score of each test route, as indicated in step 640. The test route is then set up as the route in the network, as indicated in step 650.

Thus, while there have been shown, described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-30. (canceled)

31. A method for setting up a route in a packet-switched network of data-linked network nodes, said route connecting a start node to a destination node through intermediate nodes, the method comprising:
determining a plurality of test routes with respective quality of service features;
calculating a correlation parameter for each of the plurality of test routes, the correlation parameter describing a distance correlation with a reference route present in the network;
applying a scoring function for a weighted evaluation of quality of service features to at least one quality of service feature of the each of the plurality of test routes to obtain a score for the each of the plurality of test routes, the correlation parameter being included as a quality of service feature in a function argument;
selecting a selected test route according to a selection rule for the score of the each of the plurality of test routes; and
setting up the selected test route as the route in the network.

32. The method as claimed in claim 31, wherein the correlation parameter has a maximum weighting within the scoring function.

33. The method as claimed in claim 31, wherein the selected test route has a distance of more than three network hops from the reference route.

34. The method as claimed in claim 32, wherein the selected test route has a distance of more than three network hops from the reference route.

35. The method as claimed in claim 31, wherein the selected test route has a maximum distance from the reference route.

36. The method as claimed in claim 32, wherein the selected test route has a maximum distance from the reference route.

37. A method for setting up a route in a packet-switched network of data-linked network nodes, said route connecting a start node to a destination node through intermediate nodes, comprising the steps of:
a) generating, by the start node, a route request containing quality of service features which is broadcast to the destination node, at least one correlation parameter being included as a quality of service feature which describes a distance correlation of the network path covered by the route request with a reference route in the network;
b) wherein, each intermediate node:
b1) on receiving the route request for a first time, storing the route request in a route request buffer and starting a first timer with a pre-settable first timeout period;
b2) storing route requests received during the first timeout period in the route request buffer;
b3) updating the quality of service features of the route request for each route request stored in the route request buffer;
b4) applying a scoring function for a weighted evaluation of quality of service features to at least one quality of service feature of the route requests stored in the route request buffer to obtain a first score for each route request of the stored route requests, the correlation parameter being contained in a function argument;
b5) selecting from the route requests stored in the route request buffer a selected route request according to a first selection rule for the first score upon expiration of the first timeout period; and
b6) forwarding the selected route request on a broadcast basis to adjacent network nodes;
c) wherein, the destination node:
c1) storing the route request in another route request buffer and starting a second timer with a pre-settable second timeout period upon receiving the route request for the first time;
c2) storing route requests received during the second timeout period in the another route request buffer;
c3) updating the quality of service features of each route request of the route requests stored in the another route request buffer;
c4) applying the scoring function to at least one quality of service feature of the route requests stored in the another route request buffer to obtain a second score for the each route request;
c5) selecting a second selected route request according to a second selection rule for the second score upon expiration of the second timeout period; and
c6) generating a route reply containing quality of service features which is transmitted to the start node in a backward direction at least partly through the network path traveled by the second selected route request to set up the network path as the route.

38. The method as claimed in claim 37, wherein the correlation parameter has a maximum weighting within the scoring function.

39. The method as claimed in claim 37, wherein the first selected route request is selected by the first selection rule such that the network path traveled by the first selected route request has a distance of more than three network hops from the reference route.

40. The method as claimed in claim 37, wherein the first selected route request is selected by the first selection rule such that the network path traveled by the first selected route request has a maximum distance from the reference route.

41. The method as claimed in one of claim 37, wherein each intermediate node:
a1) starting a third timer with a pre-settable third timeout period upon receiving the route request for the first time, said third timeout period elapsing after the first timeout period;
a2) storing route requests received during the third timeout period in the route request buffer;
a3) updating the quality of service features of each of the route requests stored in the route request buffer;
a4) applying the scoring function for the weighted evaluation of quality of service features to at least one quality of service feature of route requests stored in the route request buffer to obtain the first score for each route request, the correlation parameter being contained in the function argument;
a5) upon receiving a route reply, checking whether the route request stored in the route request buffer of the intermediate node after expiration of the first timeout period and during the third timeout period has, according to the first selection rule, a better score than the route request forwarded upon expiration of the first timeout period;
a6) in an event that no higher scored route request is present in the intermediate node, forwarding the route reply in the backward direction along the network path traveled by the second selected route request selected by the destination node; and
a7) in the event that a higher scored route request is present in the intermediate node, forwarding the route reply in the backward direction along the network path traveled by the route request scored higher by the intermediate node.

42. The method as claimed in claim 41, wherein the route reply received by an intermediate node is only forwarded if the third timeout period has not expired.

43. A method for setting up a route in a packet-switched network of data-linked network nodes, said route connecting a start node to a destination node through intermediate nodes, the method comprising the steps of:
a) generating by the start node a route request containing quality of service features which is broadcast to the destination node, at least one correlation parameter being included as a quality of service feature which describes a distance correlation of the network path traveled by the route request with a reference route in the network;
b) wherein, each intermediate node receiving the route request:
b1) upon receiving the route request for the first time, storing the route request in a route request buffer and starts a first timer with a pre-settable first timeout period and a third timer with a pre-settable third timeout period;
b2) storing route requests received during the first timeout period and the third timeout period in the route request buffer;
b3) updating quality of service features of each of the route requests stored in the route request buffer;
b4) applies a scoring function for a weighted evaluation of quality of service features to at least one quality of service feature of the each of the route requests stored in the route request buffer to obtain a first score for the each route request, the correlation parameter being contained in a function argument;
b5) upon expiration of the first timeout period, selecting from the route requests stored in the route request buffer during the first timeout period a first selected route request according to a first selection rule for the first scores; and
b6) broadcasting the first selected route request to adjacent network nodes;
c) wherein, the destination node:
c1) upon receiving the route request for the first time, storing the route request in another route request buffer and starting a second timer with a pre-settable second timeout period;
c2) storing route requests received during the second timeout period in the another route request buffer;
c3) updating the quality of service features for each route request of the route requests stored in the another route request buffer;
c4) applying the scoring function to at least one quality of service feature of the each route request stored in the another route request buffer to obtain a second score for the each route request;
c5) selecting a second selected route request according to a second selection rule for the second score upon expiration of the second timeout period;
c6) generating a route reply containing quality of service features which is transmitted to the start node in a backward direction at least partly over the network path traveled by the second selected route request;
d) wherein, each intermediate node receiving the route reply:
d1) upon receiving the route reply, checking whether the route request stored in the route request buffer of the intermediate node after expiration of the first timeout period and during the third timeout period has, according to a first selection rule, a better score than the route request forwarded upon expiration of the first timeout period;
d2) in an event that no higher scored route request is present in the intermediate node, forwarding the route reply in the backward direction along the network path traveled by the route request selected by the destination node;
d3) in the event that a higher scored route request is present in the intermediate node, forwarding the route reply in the backward direction along the network path traveled by the higher scored route request;
e) wherein, the start node:
e1) upon receiving the route reply for the first time, storing the route request in a further route reply buffer and starts a fourth timer with a pre-settable fourth timeout period;
e2) storing route replies received during the fourth timeout period in the further route reply buffer;
e3) updating the quality of service features of the network path traveled for each route reply stored in the further route reply buffer;
e4) applying the scoring function to at least one quality of service feature of the route reply stored in the further route reply buffer to obtain a third score for each network path;
e5) selecting a selected route reply according to a third selection rule for the scores upon expiration of the fourth timeout period; and
e6) transmitting a data packet to the destination node in the forward direction over the network path traveled by the selected route reply to set up the route.

44. The method as claimed in claim 43, wherein the start node generates a confirmation message which is transmitted to the destination node to set up the route.

45. The method as claimed in claim 43, wherein the correlation parameter has a maximum weighting within the scoring function.

46. The method as claimed in claim 43, wherein the first selected route request is selected by the first selection rule such that the network path traveled by the first selected route request always has a distance of more than three network node hops from the reference route.

47. The method as claimed in claim 43, wherein the first selected route request is selected by the first selection rule such that the network path traveled by the first selected route request always has a maximum distance from the reference route.

48. The method as claimed in claim 43, wherein second selected route requests are selected by the second selection rule such that the network paths traveled by the second selected route requests always have a distance of more than three network node hops from the reference route.

49. The method as claimed in claim 43, wherein second selected route requests are selected by the second selection rule such that the network paths traveled by the second selected route requests have a progressively decreasing distance from the reference route, beginning with the network path having a maximum distance from the reference route.

50. The method as claimed in claim 43, wherein the selected route reply is selected by the third selection rule such that the network path traveled by the selected route reply has a distance of more than three network node hops from the reference route.

51. The method as claimed in claim 43, wherein the selected route reply is selected by the third selection rule such that the network path traveled by the route reply has a maximum distance from the reference route.

52. The method as claimed in claim 43, wherein the route reply received by the intermediate node is only forwarded if the third timeout period has not expired.

53. The method as claimed in claim 31, wherein a route parallel to the reference route is set up.

54. The method as claimed in claim 31, wherein each data-linked network node exchanges route information messages with other data-linked network nodes, each route information message containing data which describes whether a data-linked network node transmitting the route information message is part of the reference route.

55. The method as claimed in claim 54, wherein each route information message contains data which describes whether a data-linked network node adjacent to the data-linked network node transmitting the route information message is part of the reference route.

56. The method as claimed in claim 54, wherein each route information message contains data which describes whether a data-linked network node within 1-hop, 2-hop or 3-hop adjacency to the network node transmitting the route information message is part of the reference route.

57. A network of data-linked network nodes having network nodes which are configured to set up a route in a packet-switched network of the data-linked network nodes, said route connecting a start node to a destination node through intermediate nodes, wherein:
a plurality of test routes with respective quality of service features are determined;
for each test route a correlation parameter is calculated at each of the intermediate nodes which describes a distance correlation with a reference route present in the network;
a scoring function for a weighted evaluation of quality of service features is applied at each of the intermediate nodes to at least one quality of service feature of the test routes to obtain a score for each of the test routes, the correlation parameter being included as a quality of service feature in a function argument;
a selected test route is selected at the each intermediate node according to a selection rule for scores of the test routes; and
wherein the selected test route is set up as the route in the network.

58. A network node of a network of data-linked network configured to set up a route in a packet-switched network of the data-linked network nodes, said route connecting a start node to a destination node through intermediate nodes, wherein:
a plurality of test routes with respective quality of service features are determined;
the network node being configured to:
calculate for each of the test routes a correlation parameter which describes a distance correlation with a reference route present in the network;
apply a scoring function for a weighted evaluation of quality of service features to at least one quality of service feature of the test routes to obtain a score for each of the test routes, the correlation parameter being included as a quality of service feature in a function argument; and
select a selected test route according to a selection rule for the scores of the test routes; and
wherein the selected test route is set up as the route in the network.

59. A network of data-linked network nodes having network nodes configured to set up a route in a packet-switched network of data-linked network nodes, said route connecting a start node to a destination node through intermediate nodes, wherein:
a) the start node generates a route request containing quality of service features which is broadcast to the destination node, at least one correlation parameter being included as a quality of service feature which describes a distance correlation of a network path covered by the route request with a reference route in the network;
b) wherein each intermediate node:
b1) on receiving the route request for a first time, stores the route request in a route request buffer and starts a first timer with a pre-settable first timeout period;
b2) stores route requests received during the first timeout period in the route request buffer;
b3) for each route request stored in the route request buffer, updates the route request's quality of service features of each route request;
b4) applies a scoring function for a weighted evaluation of quality of service features to at least one quality of service feature of the route requests stored in the route request buffer to obtain a first score for each route request, the correlation parameter being contained in a function argument;
b5) on expiration of the first timeout period, selects from the route requests stored in the route request buffer a route request according to a first selection rule for first scores; and
b6) forwards the selected route request on a broadcast basis to adjacent network nodes;
c) wherein the destination node:
c1) on receiving the route request for the first time, stores the route request in another route request buffer and starts a second timer with a pre-settable second timeout period;
c2) stores the route requests received during the second timeout period in the other route request buffer;
c3) for each route request stored in the other route request buffer, updates quality of service features of each route request;
c4) applies the scoring function tout least one quality of service feature of the route requests stored in the other route request buffer to obtain a second score for each route request;
c5) on expiration of the second timeout period, selects the route request according to a second selection rule for the second scores; and
c6) generates a route reply containing quality of service features which is transmitted to the start node in a backward direction at least partly through the network path traveled by the route request to set up the network path as the route.

60. A network node of a network of data-linked network nodes configured to set up a route in a packet-switched network of data-linked network nodes, said route connecting a start node to a destination node through intermediate nodes based on the method of claim 37.

61. A network of data-linked network nodes having network nodes configured to set up a route in a packet-switched network of the data-linked network nodes, said route connecting a start node to a destination node through intermediate nodes, wherein:
a) the start node generates a route request containing quality of service features which is broadcast to the destination node, at least one correlation parameter being included as a quality of service feature which describes a distance correlation of the network path traveled by the route request with a reference route in the network;
b) wherein each intermediate node receiving a route request:
b1) on receiving the route request for a first time, stores the route request in a route request buffer and starts a first timer with a pre-settable first timeout period and a third timer with a pre-settable third timeout period;
b2) stores route requests received during the first timeout period and during the third timeout period in the route request buffer;
b3) for each route request stored in the route request buffer, updates the quality of service features of each route request;
b4) applies a scoring function for a weighted evaluation of quality of service features to at least one quality of service feature of the route requests stored in the route request buffer to obtain a first score for each route request, the correlation parameter being contained in a function argument;
b5) on expiration of the first timeout period, selects from the route requests stored in the route request buffer during the first timeout period a route request according to a first selection rule for first scores;
b6) broadcasts the route request selected to adjacent network nodes;
c) wherein the destination node:
c1) on receiving the route request for the first time, stores the route request in another route request buffer and starts a second timer with a pre-settable second timeout period;
c2) stores route requests received during the second timeout period in the other route request buffer;
c3) for each route request stored in the other route request buffer, updates the quality of service features of each route request;
c4) applies the scoring function to at least one quality of service feature of the route requests stored in the other route request buffer to obtain a second score for each route request;
c5) on expiration of the second timeout period, selects a plurality of route requests according to a second selection rule for the second scores;
c6) generates a route reply containing quality of service features which is transmitted to the start node in a backward direction at least partly through the network path traveled by the route request;
d) wherein each intermediate node receiving the route reply:
d1) on receiving the route reply, checks whether the route request stored in the route request buffer of the intermediate node after expiration of the first timeout period and during the third timeout period has, according to the first selection rule, a better score than the route request forwarded on expiration of the first timeout period;
d2) in an event that no higher scored route request is present in the intermediate node, forwards the route reply in the backward direction along the network path traveled by the route request selected by the destination node;
d3) in the event that a higher scored route request is present in the intermediate node, forwards the route reply in the backward direction along the network path traveled by the higher scored route request;
e) wherein the start node:
e1) on receiving the route reply for the first time, stores the route request in a further route reply buffer and starts a fourth timer with a pre-settable fourth timeout period;
e2) stores route replies received during the fourth timeout period in the further route reply buffer;
e3) for each route reply stored in the further route reply buffer, updates the quality of service features of the network path traveled;
e4) applies the scoring function to at least one quality of service feature of the route replies stored in the further route reply buffer to obtain a third score for each network path;
e5) on expiration of the fourth timeout period, selects a route reply according to a third selection rule for scores;
e6) transmits a data packet to the destination node in the forward direction through the network path traveled by the route reply selected, to set the route.

62. A network node of a network of data-linked network nodes configured to set up a route in a packet-switched network of the data-linked network nodes, said route connecting a start node to a destination node through intermediate nodes based on the method of claim 43.
